(19) United States
(12) Patent Application Publication
(10) Pub. No.: US 2010/0068336 A1
(43) Pub. Date: Mar. 18, 2010

(54) Method and System for Processing Oilseeds

(76) Inventors: Vijay Singh, Savoy, IL (US); James E. Pettigrew, Champaign, IL (US); Carl M. Parsons, Champaign, IL (US); George C. Fahey, Champaign, IL (US)

Correspondence Address: GREER, BURNS & CRAIN, LTD., Suite 2500, 300 South Wacker Drive, Chicago, IL, 60606, US

(21) Appl. No.: 12/466,250

(22) Filed: May 14, 2009

Related U.S. Application Data
(60) Provisional application No. 61/127,560, filed on May 14, 2008.

(51) Int. Cl. A23L 1/20; A23K 1/00; A23K 1/18; A23J 1/14; A23J 3/30; A23J 3/32; A23J 3/34; B02C 11/08

(52) U.S. Cl. 426/2; 426/481; 426/238; 426/442; 426/44; 426/46; 426/629; 426/425; 426/630; 99/510; 99/536; 241/8

(57) ABSTRACT

Methods and systems for processing oilseed meal. Oilseed meal is hydrated to provide a hydrated oilseed meal. A particle size of the hydrated oilseed meal is reduced to provide a size-reduced oilseed meal. Enhanced oilseed meal is physically separated from the size-reduced oilseed meal.

### PRIORITY CLAIM AND REFERENCE TO RELATED APPLICATION

This application claims the benefit of U.S. Provisional Application Ser. No. 61/127,560, filed May 14, 2008, under 35 U.S.C. §119.

### FIELD OF THE INVENTION

A field of the invention is agriculture. Example applications of the invention include oilseed processing and animal feed products.

### BACKGROUND OF THE INVENTION

It is desirable to feed animals in efficient and cost-effective ways. A possible food source for pets, livestock, aquatic animals, etc. is oilseeds. Oilseeds are already produced in significant quantities for various purposes. However, though oilseeds (as opposed to cereal grains) have primarily been used for extraction of oil, the remaining meal has not been significantly utilized as a food source. The potential for oilseed meal to be used as animal feed for a variety of diverse animals on a large scale has not been reached for several reasons.

As one nonlimiting example, soybean can be processed to provide soybean meal (SBM), which has animal feed potential. However, while soybean meal is an excellent source of amino acids, existing SBM when used as feed presents problems in many animals. Accordingly, even though soybean is used in food for humans as an additive, its use as animal feed is severely limited. For example, the metabolizable energy (ME) in SBM for animals such as but not limited to poultry is rather low because the animal's relatively simple digestive tract is unable to capture much energy from the carbohydrates in SBM. These carbohydrates include both fiber and oligosaccharides.

It is desirable to refine oilseed to improve the nutritional quality of the oilseed. The present inventors have noted that if some or all of the carbohydrates were removed from oilseeds, the resulting products could have markedly increased economic value in diets of animal species. Removal of the carbohydrates would likely bring critical specific improvements in the acceptability of oilseeds in companion animal diets.

### SUMMARY OF THE INVENTION

According to embodiments of the present invention, methods and systems for processing oilseed meal are provided. In an example method for processing oilseed meal, the oilseed meal is hydrated to provide a hydrated oilseed meal. A particle size of the hydrated oilseed meal is reduced to provide a size-reduced oilseed meal. Enhanced oilseed meal is physically separated from the size-reduced oilseed meal.

### BRIEF DESCRIPTION OF THE DRAWING

FIG. 1 shows an example process and system for separating carbohydrates from an oilseed according to an embodiment of the present invention.

### DETAILED DESCRIPTION

An embodiment of the invention is a method for processing oilseeds by removing carbohydrates, including fiber, from oilseed meal. This in turn significantly increases the concentration of protein in the oilseed meal. By removing fiber content in the oilseed meal, and increasing the protein content (that is, increasing the ratio of protein to carbohydrates), the resulting enhanced oilseed meal product can be used more readily in applications such as but not limited to animal feed. Such enhanced oilseed meal product may be especially useful for use as an ingredient at higher inclusion levels in non-ruminant diets.

Example oilseeds that may be processed according to particular methods and systems of the present invention include but are not limited to soybean, sunflower, cotton, flax, canola, sesame, safflower, copra, poppy, shea nuts, palm nut and kernel, apricot and peach kernel, peanut, pumpkin, mustard, and castor bean. The oilseed used as an input to an example processing method may include oilseed meal that is a result of oil extraction, such as by solvent extraction (e.g., ethanol, acetone, ether, hexane, etc.), oilseed that is processed to provide oilseed meal, and/or an agricultural substrate that includes the oilseed or oilseed meal with other agriculture products.

Preferred embodiments will now be discussed with respect to the drawing. The drawing includes schematic figures that are not to scale, which will be fully understood by skilled artisans with reference to the accompanying description. Features may be exaggerated for purposes of illustration. From the preferred embodiments, artisans will recognize additional features and broader aspects of the invention.

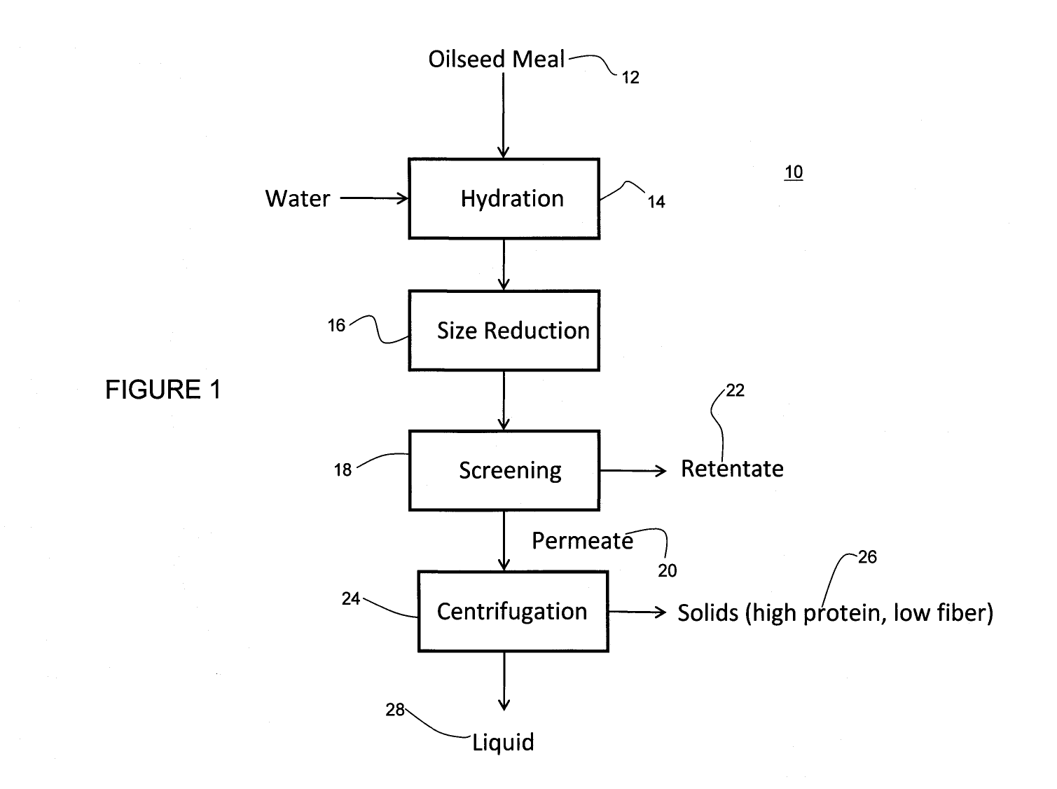

Generally, example methods of the present invention include physical processing of oilseed, supplemented in certain example embodiments with chemical or enzymatic processing, to reduce (e.g., separate) carbohydrate content. A nonlimiting example of the separated carbohydrate content is crude fiber content. An example method 10 for processing oilseeds is shown in FIG. 1.

Oilseed meal 12 is an example input for processing according to embodiments of the present invention. To provide the oilseed meal 12, the oilseed may be pretreated, including but not limited to by oil removal. Oil removal may include oil extraction using any of various methods, which will be understood by those of ordinary skill in the art. Nonlimiting oilseed pretreatment acts for oil removal include extraction via solvent, extraction via mechanical methods (e.g., crushing), water extraction, etc. The oilseed meal may be provided in other ways (e.g., procuring already-produced oilseed meal), in which case oil removal may, but need not, be omitted.

The resulting oilseed meal (i.e., oil-extracted meal) 12 can be used for the acts that follow. As a nonlimiting example method using soybean, soybean meal (SBM) may be used after oil extraction. In addition to oil removal, other pretreatment steps are possible for oilseed or oilseed meal including, but not limited to, size reduction such as grinding (e.g., fine grinding).

Following pretreatment, if any, the oilseed meal 12 is hydrated 14. For example, the oilseed meal may be soaked in water. The water may be, for example, tap water, distilled water, etc. Hydration may take place, as a nonlimiting example, within any of various appropriate containers, such as but not limited to tanks, e.g., stainless steel or others, continued stirred tank reactor (CSTR), plug-flow reactor, etc. The relative amounts of the oilseed meal and water, appropriate container for hydration, hydration time, or other conditions for hydration may vary depending on, for example, the temperature used, the type of oilseed, etc. During hydration, the mixture may be agitated and/or the pH of the mixture may be adjusted, though these additional acts are not required.

Using a nonlimiting example of soybean meal as the oilseed meal input 12, the hydrating 14 may include soaking the soybean meal in one part soybean meal and 1.5 parts water (by weight or by volume), though this ratio may vary (e.g., 1 to 1, 2 to 1, etc.). An example temperature for hydration of soybean meal is 45 to 52° C., and an example hydration time is 5 minutes to 48 hours, with a more particular example range of 3 to 12 hours.

After hydrating 14, the particle size of the hydrated oilseed meal is reduced 16, providing a size-reduced oilseed meal. A nonlimiting example act for reducing the particle size of the hydrated oilseed meal is grinding. As a nonlimiting example method of reducing the particle size of an oilseed such as soybean, hydrated (soaked) soybean meal may be ground, for example in a mill Any suitable mill may be used for grinding the hydrated oilseed meal. Alternative size reduction techniques include, but are not limited to, sonication, extrusion, etc. A desired final particle size releases the particles (proteins plus other compounds, such as but not limited to sugars, ash, etc.) that are stuck to the fiber fraction for the resulting size-reduced oilseed meal. This may be used for subsequent separation.

Following the size reduction 16, one or more separation acts (e.g., physical separations) are conducted to physically separate enhanced oilseed meal containing higher protein and lower fiber from the size-reduced (e.g., ground) oilseed meal. For example, ground oilseed meal may be filtered or sieved 18 through a screen. A nonlimiting example screen for filtering or sieving size-reduced oilseed meal, such as ground soybean meal, is a 200 micrometer screen. However, it will be appreciated by those of ordinary skill in the art that the screen may be smaller or larger. An example filter or sieve separates the filtrate or permeate 20 (mostly protein) from the retentate 22 mostly carbohydrates).

An example separation further includes centrifuging 24. For example, the filtrate 20 from the filtering or sieving 18 may be centrifuged to recover enhanced oilseed meal as solids (protein) 26 from the filtrate. However, alternative separation methods, such as sedimentation, additional filtration, rotary vacuum filter, membranes, etc. are also contemplated. The remaining liquid 28 from the centrifuging 24 or other separation includes water and carbohydrates, and may also include other outputs depending on the particular pretreatment, hydrations, size reduction, and/or separation performed. Conditions for such separation will be apparent to those of ordinary skill in the art having reference to the present specification. In a nonlimiting example of separation involving soybean meal, a filtrate is centrifuged at 6000×g for 2 minutes, and the supernatant (carbohydrates, along with water mixed therewith) is removed.

The resulting enhanced oilseed meal 26 includes reduced (or negligible) crude fiber content (and possible reduced soluble sugar content) relative to the input oilseed meal, and protein content that is higher than the original input oilseed meal. Higher protein content refers to the ratio of protein to carbohydrates in the enhanced oilseed product being increased versus the oilseed (e.g., meal) input. Similarly, reduced carbohydrate or fiber content refers to the ratio of carbohydrates or fiber to protein in the enhanced oilseed product being reduced versus that of the oilseed input.

After the separation, the enhanced oilseed meal 26 may be dried. A nonlimiting example of drying includes drying in an oven. As a more particular example in a method for processing soybean, a centrifuged soybean meal may be dried in a convection oven for 24 hr at 50° C.

Additionally, though not necessarily, the fiber 22, 28 that is separated during the separation acts may be recovered and employed in any of various high-value uses. Nonlimiting examples of such uses include feedstock for biofuels and fermentable sugars.

In addition to the example physical process for separating carbohydrates from oilseeds described above and shown in FIG. 1, it is contemplated to chemically and/or enzymatically process the oilseed. Such chemical or enzymatic processing may take place during the physical carbohydrate separation shown in FIG. 1, or may be a separate act. As an example of simultaneous hydration and chemical/enzymatic processing, the hydration 14 described above may be modified by performing the hydration in the presence of a pH modifying agent, to break the disulfide bonds and protein for separating during a later separation. However, the physical separating and/or the chemical or enzymatic separating may be performed partially or entirely separately. As nonlimiting examples, the hydration may begin before adding chemicals or enzymes, chemicals and enzymes may be added after grinding, etc. An example enzymatic processing may include, but is not limited to, adding one or more of xylanases, cellulases, pectinases, proteases, amylases, carbohydrases, and alpha-galactosidase to the meal/water combination. Enzymes may be used in suitable combination if desired.

The chemical and enzymatic processes, if employed, may be performed simultaneously or sequentially, with the chemical process either prior to or subsequent to the enzymatic process (and in sequence with or simultaneously with hydration). Depending on the chemicals used, the container used for the hydration/chemical step may need to be selected and modified to be suitable for these chemicals. In some methods, the chemical or enzymatic processes employed may require varying the processing conditions, as will be appreciated by those of ordinary skill in the art.

In a nonlimiting example method involving physical and chemical processing of soybean meal, the hydration 14 in FIG. 1 may further include soaking the soybean meal in water with a pH modifying agent, such as but not limited to sulfur dioxide, and/or enzymes. In a more particular example hydration/chemical step, soybean meal may be soaked in water such that one part soybean meal and 1.5 parts water are combined with a pH-lowering composition, such as but not limited to 600 ppm of sulfur dioxide (sodium metabisulfite) or 2% (wt) of sulfuric acid (H₂SO₄). Subsequent size reduction and physical separation (e.g., screening and centrifugation) separate carbohydrates to provide an enhanced soybean meal.

Processing oilseed meal, such as soybean meal with hydration (with or without chemical and/or enzymatic processing), size reduction, and separation reduces fiber content and improves protein content of the oilseed. Removal of some or all carbohydrates (e.g., crude fiber content) and increasing relative protein content can provide improved acceptability of the enhanced oilseed products, such as but not limited to soy products, in companion animal diets, including non-ruminant diets.

It will be understood that a system for performing methods according to embodiments of the present invention may include any suitable equipment and/or materials for performing the individual acts in the particular process that is employed, including those for pretreatment (including but not limited to oil extraction and/or size reduction), hydration, size reduction, and separation (including but not limited to screening or filtering and centrifugation), as well as equipment and/or materials for any recovery, drying, post-processing, storage, etc. Thus, the equipment and materials described herein are merely examples, and the present invention is not to be limited to the specific equipment and materials described herein.

To illustrate features and advantages of example separation methods and systems, as well as enhanced oilseed products, more specific example methods and systems are described herein as applied to soybean. However, it will be appreciated by one of ordinary skill in the art that other oilseeds may be processed in the alternative, and that the present invention is not to be limited to processing of soybean or soybean meal, but can be applied to various oilseeds including but not limited to those additional oilseeds disclosed herein.

Soybean meal (SBM) is an excellent source of amino acids for animals, but the inventors have recognized that more refined soy products can provide significant improvement over existing SBM for administering to an animal. SBM is composed of approximately 55% protein, 18% carbohydrates, 7% ash, and 4% total lipids. The carbohydrates primarily include disaccharides (sucrose), oligosaccharides (verbascose, stachyose, and raffinose), and complex polysaccharides (hemicelluloses, pectin, cellulose).

Removal of carbohydrates from soybean meal can increase the concentration of protein and energy in the resulting enhanced soybean meal, and can also recover carbohydrate as a feedstock for other valuable products. If these carbohydrates can be cost-effectively removed using physical, chemical, and/or enzymatic bioprocesses, the resulting soy product can have markedly increased economic value. Significant (as a nonlimiting example, approximately 80 to 90%) removal of carbohydrates of SBM potentially could increase the protein content to a large extent (as a nonlimiting example, 63-65% or more).

As a nonlimiting illustrative example, the meal equivalent (ME) value of SBM for animals such as poultry is rather low because the animal's relatively simple digestive tract is unable to capture much energy from the carbohydrates (e.g., fiber and oligosaccharides) in SBM. If some or all of the carbohydrates are removed, the resulting soy product can provide markedly increased economic value in diets of animals (as nonlimiting examples, poultry, aquatic species, pigs (especially young ones), and many others). Accordingly, carbohydrate removal according to example methods and systems of the present invention can provide significant, specific improvements in the acceptability of soy products in companion animal diets.

Though certain other techniques are available for processing soybean, these techniques introduce additional concerns making the resulting products less desirable for large-volume animal feed. For example, soybean protein concentrate (SPC) and soybean protein isolate (SPI) are two high protein and low fiber products that are produced from soybean meal. Soy protein concentrate (SPC) is made by extraction of the oligosaccharides and other soluble carbohydrates from SBM. Soy protein isolate (SPI) is made by acid precipitation of the protein, effectively eliminating all of the carbohydrates. Fermented soybean meal (FSBM) is another example. Other processes, such as Hamlet Protein, treat soybean with enzymes to modify the carbohydrate content.

However, the processes required for providing SPC and SPI are expensive and complicated. Both are too expensive to include in most animal feeds, and thus are conventionally limited to low volume specialty uses, not high-volume animal feed uses. Further, the particular processes used to provide SPC and SPI may adversely affect the protein. Thus, supplementation may be necessary in diets containing these products, versus diets containing SBM.

For example, although the processing of SBM to SPC, SPI, or FSBM concentrates the protein, resulting in higher crude protein concentrations, it also appears to change the amino acid composition of the protein, increasing the proportion of the protein accounted for by several of the essential amino acids, and may substantially reduce the proportion of methionine and tryptophan. The reduction in methionine is of special concern because it accentuates the limitation of methionine that is a characteristic of soy protein. Accordingly, animal diets containing SPC may require more methionine supplementation than diets containing SBM.

Reasons for the differences in amino acid compositions between SPC and SBM are not clear, but there are two mechanisms by which the production of SPI may change the amino acid composition. First, because not all protein is solubilized in the alkaline extraction step, and not all solubilized protein is precipitated in the isoelectric precipitation step, fractionation of protein occurs. This fractionation reduces the sulfur-containing amino acids. Second, alkaline extraction of SBM may damage certain amino acids.

Thus, even though SPC, SPI, and FSBM can be made by removal of carbohydrates from SBM and have higher crude protein concentrations, SPC and SPI apparently have poorer protein quality (lower methionine concentration in the protein) than SBM. SPC and SPI also have substantially lower concentrations of oligosaccharides and of glycinin and β-conglycinin, two antigenic proteins that are detrimental to young pigs and probably other animals. FSBM likely also has lower concentrations of these antinutritional factors.

Example embodiments of the present invention as applied to soybean provide physical along with optional chemical and/or enzymatic treatments for increasing the concentration of protein and energy and for reducing the concentration of carbohydrates in SBM. Soybean applications for products produced according to example methods of the present invention are useful (for example) for companies that process soybeans to produce soybean oil, soybean meal, SPC, and SPI.

In an example physical separation method using a soybean meal input, hydration followed by size reduction and separation are employed to separate the carbohydrate fraction in SBM. This example process for oilseeds can be optimized for hydration time and soak temperature. Further, this physical separation may be supplemented with chemical treatment. For example, dilute acid treatment (as a nonlimiting example, ˜2.0 wt % H₂SO₄) can be applied to SBM to help remove carbohydrates and increase the protein content. The dilute acid treatment can be optimized for acid concentration. To combine the processes, the physical separation process can be modified in the hydration act, which can be done in the presence of sulfur dioxide to break the disulfide bonds and loosen the protein matrix for better separation of carbohydrate and protein during the sieving. Preliminary testing with this latter example process resulted in negligible amount of crude fiber in the resulting enhanced soybean meal.

Further, as another supplement to the physical separation process described above, protease and cell wall-degrading enzymes may be used to reduce or degrade carbohydrate fractions. For example, SBM can be treated with several enzymes or combinations of enzymes to degrade oligosaccharides and polysaccharides. Commercial xylanases, cellulases, pectinases, and alpha-galactosidases are possible. Process conditions (pH, temperature, incubation times, etc.) can be optimized for maximum activity levels.

In more particular example methods for processing soybean to remove carbohydrates and increase protein concentration according to embodiments of the present invention, soybean meal was provided (obtained from a feed mill), and the soybean meal was soaked in water (one part soybean meal and 1.5 parts water) for 3 to 12 hr at 45-52° C. with and without 600 ppm of sulfur dioxide (sodium metabisulfite) or 2% sulfuric acid (e.g., ˜2.0 wt % H₂SO₄) or cellulases. After soaking, the meal was finely ground in a Quaker City Mill. Following grinding, the meal was filtered through a 200 micron screen. Some of the filtrate samples were centrifuged at 6000×g for 2 minutes. The supernatant was discarded. The centrifuged meal was dried in a convective oven for 24 hr at 50° C. After drying, the meal was analyzed for its composition.

A slightly modified process for hydration, size reduction, and sieving was also evaluated. Modification was in the hydration, which was performed in the presence of sulfur dioxide to break the disulfide bonds and loosen the protein matrix for better separation of carbohydrate and protein during the sieving. As an example enzymatic treatment, SBM was treated with several enzymes or combinations of enzymes to reduce or degrade carbohydrate fractions (as a nonlimiting example, degrade oligosaccharides and polysaccharides). The following classes of enzymes and enzyme combinations were evaluated: 1) xylanase; 2) cellulase; 3) pectinase; 4) beta-glucanase; 5) alpha-galactosidase; 6) xylanase, cellulase, pectinase, and beta-glucanase; and 7) xylanase, cellulase, pectinase, and alpha-galactosidase. Specific enzymes in each class were selected strategically to attack the chemical structures in SBM. Using these example methods, process conditions (e.g., pH, temperature, and incubation time) can be optimized for maximum activity levels. Recovery of solids after sieving can be done by centrifugation. After treatment, products are analyzed for different carbohydrates.

The results of example methods are shown below in Table 1. As shown, two treatments (soybean meal centrifuge with H₂O and soybean meal centrifuged with SO₂) resulted in negligible crude fiber content (0.01 and 0.09%) and high protein content (83.82 and 78.46%, respectively).

TABLE 1
Composition of soybean meal after processing

| | | | | Ave | | |
|---|---|---|---|---|---|---|
| | Samples | | | Protein | Crude Fiber | |
| Sample | Description | Moisture | Protein (db) | (db) | (db) | Ave Crude Fiber (db) |
| 41973 | SBM + 270M | 3.29 | 53.14 | | 4.54 | |
| | w/SO2 | | | | | |
| 41973 | | 3.29 | 53.54 | 53.34 | 4.69 | 4.62 |
| 41974 | SBM + 270M | 5.69 | 58.60 | | 4.23 | |
| | w/H20 | | | | | |
| 41974 | | 5.69 | 59.07 | 58.84 | 4.16 | 4.19 |
| 41975 | SBM Centrifuge | 3.86 | 78.55 | | 0.08 | |
| | w/SO2 | | | | | |
| 41975 | | 3.86 | 78.37 | 78.46 | 0.10 | 0.09 |
| 41976 | SBM Centrifuge | 2.98 | 83.56 | | 0.01 | |
| | w/H2O | | | | | |
| 41976 | | 2.98 | 84.07 | 83.82 | 0.01 | 0.01 |
| 41977 | SBM 2% H2SO4 | 3.27 | 74.38 | | 5.36 | |
| 41977 | | 3.27 | 73.94 | 74.16 | 5.36 | 5.36 |

The results show that processing of soybean meal (SBM) with hydration, size reduction, and separation, with possible additional chemical and/or enzymatic processing, reduces fiber content and improves protein content. Protein content can increase, as a nonlimiting example, from 53% to more than 78%. Crude fiber can be reduced, as a nonlimiting example, from 4.2% to less than 0.09%.

The resulting enhanced soybean meal and other enhanced oilseed meal can be produced in a cost-effective manner and administered to animals (e.g., fed to animals) using methods understood by those of ordinary skill in the art. Example methods, systems, and/or products of the present invention provide cost-effective soy products that can be superior to SBM (and to other meals, or other high-protein feeds) in providing nutrients to animals. Example methods and systems provide more value to end-users that conventional oilseed meal, such as SBM. Additionally, the enhanced oilseed meal may be used in various other food products. As a nonlimiting example, enhanced oilseed meal may be used as an additive for an existing food product.

Example enhanced oilseed meal, such as but not limited to enhanced soybean meal, can also be more competitive than existing SBM products against potential substitutes including distiller dried grains with soluble (DDGS) and crystalline amino acids for diets of various animals. A nonlimiting example is poultry diets and diets for pigs (newly weaned pigs, older pigs, etc.) Recent increases in feedstuff cost magnify the value of feed efficiency, and therefore magnify the increased energy density provided by example products. The diversion of large quantities of fats and oils from feed use to production of biodiesel amplifies the economic advantage of such energy-dense products when applied to both poultry and pig diets. Such example products are also likely to overcome resistance of certain industries to soy products, and may therefore gain significant inroads into a rapidly growing market. Such products are likely to also be attractive to aquacultural nutritionists. Also, the fiber fraction recovered in example methods of the present invention may also provide other high-value micronutrients, such as but not limited to phytosterols and antioxidants.

While various embodiments of the present invention have been shown and described, it should be understood that other modifications, substitutions, and alternatives are apparent to one of ordinary skill in the art. Such modifications, substitutions, and alternatives can be made without departing from the spirit and scope of the invention, which should be determined from the appended claims.

Various features of the invention are set forth in the appended claims.

1. A method for processing oilseed meal, comprising:
hydrating the oilseed meal to provide a hydrated oilseed meal;
reducing a particle size of the hydrated oilseed meal to provide a size-reduced oilseed meal; and
physically separating enhanced oilseed meal from the size-reduced oilseed
meal.

2. The method of claim 1, further comprising:
extracting oil from an oilseed to provide the oilseed meal.

3. The method of claim 1, further comprising:
before said hydrating, reducing a particle size of the oilseed meal.

4. The method of claim 1, wherein said hydrating comprises soaking the oilseed meal in water.

5. The method of claim 4, wherein the water comprises at least one of tap water and distilled water.

6. The method of claim 4, further comprising:
adjusting a pH of the water.

7. The method of claim 1, wherein said reducing a particle size of the hydrated oilseed meal comprises at least one of grinding, sonication, and extrusion.

8. The method of claim 1, wherein said separating comprises at least one of filtering, sieving, centrifuging, sedimentation, vacuum filtering, and membrane filtering.

9. The method of claim 1, wherein said separating comprises:
at least one of filtering and sieving the size-reduced oilseed meal; and
centrifuging the size-reduced oilseed meal after said at least one of filtering and sieving.

10. The method of claim 1, further comprising:
recovering enhanced oilseed meal from the size-reduced oilseed meal after said separating.

11. The method of claim 10, further comprising:
recovering a carbohydrate fraction from the size-reduced oilseed meal after said separating.

12. The method of claim 1, further comprising:
chemically processing the oilseed meal;
wherein said chemically processing uses a pH modifying agent.

13. (canceled)

14. (canceled)

15. The method of claim 12, wherein said chemically processing uses at least one of sulfur dioxide and sulfuric acid.

16. The method of claim 1, further comprising:
enzymatically treating the oilseed meal.

17. (canceled)

18. (canceled)

19. The method of claim 16, wherein said enzymatically treating uses at least one of xylanases, cellulases, pectinases, proteases, amylases, carbohydrases, and alpha-galactosidase.

20. The method of claim 1, wherein the oilseed meal comprises soybean meal;
wherein said hydrating comprises soaking the soybean meal in water to provide a hydrated soybean meal;
wherein said reducing a particle size comprises reducing a particle size of the hydrated soybean meal to provide a size-reduced soybean meal; and
wherein said physically separating comprises separating enhanced soybean meal from the size-reduced soybean meal, wherein said separating enhanced soybean meal comprises at least one of sieving and filtering the size-reduced soybean meal and subsequent centrifuging the filtered or sieved soybean meal.

21. The method of claim 1, wherein the oilseed meal comprises meal for at least one of soybean, sunflower, cotton, flax, canola, sesame, safflower, copra, poppy, shea nut, palm nut and kernel, apricot and peach kernel, peanut, pumpkin, mustard, and castor bean.

22. A system for performing the method of claim 1.

23. (canceled)

24. (canceled)

25. An enhanced oilseed meal made by the method of claim 1.

26. (canceled)

27. (canceled)

28. A method comprising:
administering the enhanced oilseed meal of claim 25 to at least one animal.

29. (canceled)

30. A food product comprising the enhanced oilseed meal of claim 25.

31. (canceled)

32. (canceled)

33. (canceled)

34. A method for processing oilseed comprising:
providing oilseed meal;
hydrating the oilseed meal to provide a hydrated oilseed meal;
releasing particles including proteins in the hydrated oilseed meal from a fiber fraction; and
physically separating enhanced oilseed meal including said released particles from the fiber fraction.

35. The method of claim 34,
wherein said releasing particles comprises reducing a particle size of the hydrated oilseed meal to provide a size-reduced oilseed meal;
wherein said physically separating comprises physically separating the enhanced oilseed meal from the size-reduced oilseed meal.

36. (canceled)

37. A system for processing oilseed meal comprising:
means for hydrating the oilseed meal to provide a hydrated oilseed meal;
means for releasing particles including proteins in the hydrated oilseed meal from a fiber fraction, said means for releasing including means for reducing a size of the hydrated oilseed meal to provide a size-reduced oilseed meal; and
means for physically separating enhanced oilseed meal including said released particles from the fiber fraction in the size-reduced oilseed meal.
